(19) United States
(12) Patent Application Publication
(10) Pub. No.: US 2025/0278643 A1
(43) Pub. Date: Sep. 4, 2025

(54) EMBEDDED GENERATIVE AI-BASED DOMAIN EXPLANATIONS

(71) Applicant: Intuit, Inc., Mountain View, CA (US)

(72) Inventors: Ishani DOSHI, San Diego, CA (US); Anant SAXENA, San Diego, CA (US); Chase ROOSSIN, San Diego, CA (US); Meng CHEN, Mountain View, CA (US); Rohan Karthik ADGALA, San Diego, CA (US); Varadarajan SRIRAM, San Diego, CA (US)

(21) Appl. No.: 18/592,358

(22) Filed: Feb. 29, 2024

(51) Int. Cl. G06N 5/022

(52) U.S. Cl. CPC G06N 5/022

(57) ABSTRACT

Certain aspects of the disclosure provide systems and methods for generating and presenting generative artificial intelligence (AI) explanations of application outputs associated with users. In certain embodiments, user and application information may be used by a knowledge engine to generate a knowledge explanation. The knowledge explanation may be provided to a GenAI model to output the GenAI explanation. The GenAI explanation may then be displayed within the application.

### BACKGROUND

### Field

Aspects of the present disclosure relate to artificial intelligence, and more specifically, to generative AI explanations associated with application outcomes.

### Description of Related Art

A common, if not ubiquitous, feature of software applications is a function or facility for providing explanations of the application's features, such as a “help” function that may present a variety of different helpful content. Less ubiquitous are application functions that provide explanations of an application's outputs. For example, a calculator application may include a help function for telling you how to calculate the square root of a number, but it likely does not include any explanation of why, for example, the square root of 4 is 2. Even when an application provides an explanation of its output, the explanation is often generic, which is to say it may be neither domain nor user-specific, or in other words, fails to account for the user's specific context. Such “pre-canned” explanations may be confusing and generally ineffective for users. Further, when presented with such generic explanations of application output, users may not be confident that the application generated the correct output, especially in complex domains. Consequently, users may become disillusioned with and abandon the application. This is especially true when the application's output is sensitive, such as a credit approval decision, an income tax return status, and the like.

The complexity of providing meaningful explanations regarding application outputs to a broad set of users, each having unique contexts (e.g., unique attributes and domains) is increased where applications rely on domain-specific models, domain-specific rules, and/or domain-specific knowledge, This is because an explanation of an application's domain-specific output may be underpinned by complicated determinations (e.g., tax rule determinations), calculations, and potentially large amounts of data. Thus, meaningful explanations for an application's outputs in complex domain has proven a persistent technical problem in the art that has evaded attempts at automation and advancement.

Accordingly, there is a need for improved systems and methods for providing meaningful explanations of applications' output.

### SUMMARY

Certain aspects provide a computer-implemented method, comprising: receiving a request for a generative artificial intelligence (AI) explanation of an application output associated with a user and an application; receiving user application session information associated with the user and the application output; providing the user application session information to a knowledge engine; receiving from the knowledge engine a knowledge explanation; generating a prompt for a generative AI model based on the knowledge explanation; providing the prompt to the generative AI model; receiving from the generative AI model the generative AI explanation; and providing the generative AI explanation for display within the application.

Certain aspects provide a computer-implemented method, comprising: receiving a request for a generative artificial intelligence (AI) explanation of an application output associated with a user and an application; receiving user application session information associated with the user and the application output; providing the user application session information to a knowledge engine; receiving from the knowledge engine a knowledge explanation; generating a prompt for a generative AI model based on the knowledge explanation, comprising: parsing the knowledge explanation with a parser model to identify information elements, wherein the parser model is trained to reduce a number of tokens of the prompt; identifying one or more instructions based on the information elements; and adding the information elements and the one or more instructions to the prompt for the generative AI model; providing the prompt to the generative AI model; receiving from the generative AI model the generative AI explanation; and providing the generative AI explanation for display within the application.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example application system.

FIG. 2 depicts an example user interface displaying a user-specific generative AI explanation within the application.

FIG. 3 depicts an example system for generating and displaying the user-specific generative AI explanations within the application.

FIG. 4 depicts an example sequence diagram for generating and displaying the user-specific generative AI explanations within the application.

FIG. 5 depicts an example method for generating a user-specific generative AI explanation of an application output associated with a user and an application.

FIG. 6 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for generating generative artificial intelligence (GenAI) explanations associated with applications' outputs based on domain and user-specific information. In particular, certain embodiments are directed to generating GenAI-based explanations comprising domain- and user-specific explanations of an application's output embedded within an application user interface. These embodiments improve upon the state of the art by providing an automated method for generating meaningful GenAI-based explanations of applications outputs for users based on domain and user-specific context. Generally, GenAI-based explanations may include textual and/or graphical descriptions regarding how and/or why an application reached a decision, determination, calculation, interpretation, or other outcome.

As above, applications may be configured to supply generic explanations of features, and in some cases outputs, to users. However, conventionally, such explanations often come in the form of generic or predetermined (e.g., “pre-canned”) explanations. Examples of generic explanations may include frequently asked question (FAQ) sections that are presented to all users regardless of their specific attributes and/or context. As described herein, these generic explanations may contain irrelevant or (unintentionally) misleading information, such as instructions on how to resolve a problem in a different version of an application than the inquiring user is using. Consequently, such generic explanations can cause user confusion and lead to user abandonment of an application.

Generic explanations, like FAQs, are predominant and often ineffective because it is impractical, if not impossible, to preconceive every question, issue, or outcome a user may face, and to prepare, in advance, an answer to the same—thus the term “frequently” asked questions, not “all” or “any” asked question. Further, information repositories that may be sources for explanatory content are often vast and not necessarily structured to provide meaningful explanations to user queries. Further, creation, maintenance, and updates to things like FAQs may require significant resources and often lag if not fall completely out of sync with current versions of the applications for which they are written. Because applications are often updated, new explanations of features and potential outputs need to be generated at a near constant rate, which is impractical.

This general problem is exacerbated in complex (e.g., technical) domains where an explanation may necessarily include technical, domain-specific, and unfamiliar terminology, as well as reference to complex underlying data. Comprehension of such information may be impractical for many non-expert users. For example, an application configured to make tax determinations may need to base any explanation of such a determination on 7,000 (and counting) pages of United States tax code as well as 75,000 (and counting) pages of regulations and guidelines. Generating a meaningful, user-specific explanation of a tax determination is thus a prohibitively complex task that has resisted automation.

Another practical problem in conventional attempts to generate explanatory information is that the explanatory information often provided separated from the application's user interface, such as provided in an external web-based FAQ outside the confines of the application's workflow user interface. This creates an experience disconnect and discontent for users that do not want to move between applications and interfaces to better understand the output of a given application.

Aspects described herein provide technical solutions to the aforementioned problems. In particular, embodiments described herein provide systems and methods for generating GenAI-based explanations associated with application features, outputs, and/or outcomes based on domain and user-specific information. Herein, “GenAI” generally refers to generative artificial intelligence systems, such as machine learning models, like large language models (LLMs), which are capable of understanding users' natural language queries, and providing natural language responses. Moreover, such GenAI systems can access and incorporate user-specific information (such as tax information for a given user) and domain-specific information (such as tax laws, rules, and regulations for a particular state in the United States) when generating a GenAI explanation of an application's output (e.g., a tax determination).

The systems and method for generating GenAI explanations, described herein, have many practical applications, such as those described above, as well as, for example, generating an explanation accompanying a credit approval decision within an application configured to make credit decisions based on the user's data and interactions with the application, as well as credit approval domain knowledge and calculations. Such an explanation may include a description of the user's attributes, such as income information and how that income affected the approval decision. Thus, the user beneficially receives a personalized explanation of the outcome and may verify the information utilized by the application.

Beneficially, aspects described herein utilize GenAI models to transform complex, domain-specific application outputs (e.g., a tax calculation for a particular state) into a clear and concise explanation suitable for non-expert users. For example, a tax application may understand based on a user's tax information that the user is not a tax expert and therefore the GenAI explanation needs to be tailored for a non-expert user. The opposite may be true, where an application is aware that its user is an expert and can generate a more complex GenAI explanation, e.g., comprising more technical details regarding the output.

GenAI models may generally be configured to generate text, image, and other data outputs for explanations based on an input prompt. A prompt is generally an instruction or request, often posed in natural language, such as a user query regarding an application's output, which is processed by a GenAI model to generate a GenAI explanation. In some cases, prompts are generated through a text and/or voice interface. Prompts may be transformed into numerical representations, such as tokens, so that they may be processed by GenAI models.

Generative pre-trained transformer (GPT) models are a specific type of GenAI model based on a transformer architecture (e.g., an architecture that uses an encoder-decoder structure and does not rely on recurrence and/or convolutions to generate an output), which may be “pre-trained” in an unsupervised manner (e.g., it learns from data without being given explicit instructions on what to learn). GPT models process input prompts and predict the best possible response based on the input prompt. GPT models may be particularly useful in embodiments described herein because they can be trained in an unsupervised manner based on large, existing datasets and domain-specific information (e.g., tax laws, rules, and regulations). This gives such models an “understanding” of the domain-specific information that exceeds that possible by an ordinary human.

A technical problem with GenAI models, such as GPT models and other LLMs, is ensuring the GenAI explanation is based on the right user and domain-specific information, and that the output is accurate. It is known that GenAI models can “hallucinate” and thereby provide factually incorrect or nonsensical output. Embodiments described herein beneficially engineer input prompts to include explicit instructions that overcome this technical problem. Such instructions may, for example, provide exemplary input and output examples to guide the GenAI model in generating a meaningful GenAI explanation based on an application's output.

Further, embodiments described herein beneficially augment an input prompt with domain-specific information, which improves the GenAI model's ability to generate a meaningful GenAI explanation. For example, a domain rule may be included in an input prompt, such as for calculating a square root, the prompt may include a square root rule: the square root for a first number is a second number, which when multiplied by itself gives the first number. Beneficially, then, the GenAI model may generate an explanation utilizing the domain rule, for example, an explanation may include: The square root of 4 is 2 because when 2 is multiplied by itself it gives 4.

In order to augment input prompts with domain-specific information, embodiments described herein may utilize a “knowledge engine” configured with domain knowledge, such as domain-specific models, rules, and data. In some cases, an application may utilize the knowledge engine to generate an output (such as a tax calculation) and relevant domain knowledge (e.g., the relevant tax rule) is provided to the GenAI model as domain-specific information to generate a more meaningful explanation.

Knowledge engines may incorporate a vast amount of information, which is beneficial, but may engender a technical problem when paired with GenAI models because such models may be limited in the size of the input they can process (e.g., the number of tokens they can consider in an input prompt). Such limitations may be due to the memory and processing capabilities of either the GenAI models themselves, or the processing systems upon which they are run. Generally, large input prompts (e.g., in terms of token count) may significantly increase resource usage, including power and processing time, which may increase latency of an application relying on the output of the GenAI model. Practically speaking, the number of tokens associated with domain knowledge used by a knowledge engine and intended to be used to augment an input prompt to a GenAI model may far exceed the input data limits for the GenAI model.

Aspects described herein overcome this input size technical problem by reducing the prompt size, while maintaining the benefit of the augmented domain knowledge. In certain embodiments, a parser model is used to parse (e.g., compress) the domain knowledge (e.g., information and calculations from a knowledge engine) so that an input prompt augmented with such knowledge is nevertheless usable by the GenAI model. This parsing not only beneficially reduces resource usage by the GenAI model (e.g., through reducing the input prompt's token count), but it also reduces latency of the application relying on the GenAI model's output.

Finally, embodiments described herein provide for displaying GenAI explanations directly within (e.g., integral with) an application's user interface. For example, a GenAI explanation may be displayed within the same user interface element (e.g., window) and adjacent to or otherwise near the application output to which it applies. This integration improves usability and user experience.

### Example System for Generative AI Explanations Within Applications

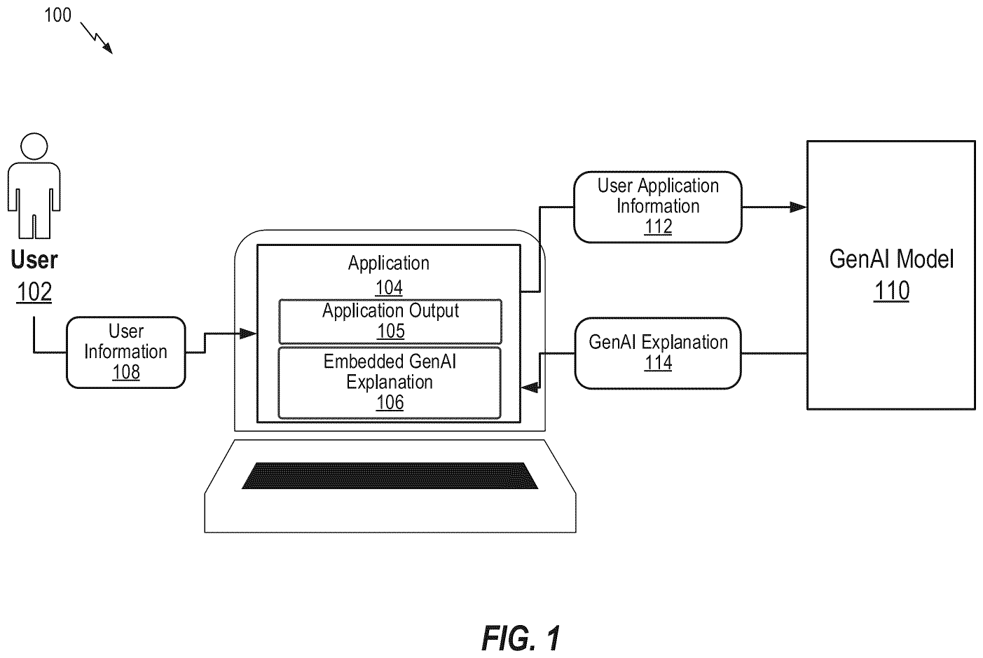

FIG. 1 depicts an example system 100 for generation and display of embedded GenAI explanations. System 100 may be used, for example, with domain-specific applications, which are generally applications configured to perform tasks associated with a particular domain or industry. Domain-specific applications may rely on domain knowledge to solve problems or complete domain-specific tasks. For example, tax calculation applications, customer support applications, medical diagnosis applications, media and content applications, are examples of domain-specific application. System 100 may be also be used with generalized applications, which are generally applications configured to perform tasks relevant to many different domains and industries, for example, a word processing application, messaging application, and others.

In FIG. 1, a user 102 interacts with application 104, for example, by providing user information 108 through a user interface associated with application 104. Based on such user information 108, application 104 may determine an application output 105. As an example, in a tax return preparation application, user 102 may provide user income information and user demographic information as inputs to the tax domain application for determining tax calculations and return preparation. As another example, in a medical diagnosis application, user 102 may provide user medical information, user symptoms, and user demographic information as inputs to the medical diagnosis application for determining medical diagnostics.

Application 104 is further configured to display an embedded GenAI explanation 106 comprising a user-specific explanation of application output 105, including, for example, domain-specific details, rules, and/or knowledge, as well as user information 108, used by application 104 to determine application output 105. Further, embedded GenAI explanation 106 may be generated for a non-expert audience, e.g., comprehensible by a non-domain expert. Returning to the tax return preparation application example, an embedded GenAI explanation may include information regarding a tax return associated with user 102, such as tax rules, credits, deductions, etc., and their application to user information 108 to generate application output 105 (e.g., a tax return). The embedded GenAI explanation 106 may be geared to a non-expert audience, e.g., for a regular taxpayer, not a tax preparer.

As another example, returning to the medical diagnostic application example, an embedded GenAI explanation may include information regarding a medical diagnosis associated with user 102, such as medical history, disease pathology, treatment, etc., based on user information 108 to generate a medical diagnosis. The embedded GenAI explanation 106 may in a manner for a patient, not a physician.

The embedded GenAI explanation may be generated in response to application 104 generating application output 105. For example, as user 102 inputs user information 108 to application 104, application 104 may determine an application output 105. Such a determination of application output 105 may induce generation of the embedded GenAI explanation 106.

In the depicted example, embedded GenAI explanation 106 is embedded within application 104, for example, displayed as a user interface element on a user interface of application 104. Embedded GenAI explanation 106 may be embedded as part of a widget, for example, an inline widget or an embedded widget. An inline widget may form part of a user interface, for example, as a banner element. An embedded widget may utilize code embedded into a user interface page of application 104. A user interface element displaying an embedded GenAI explanation 106 may be associated with, for example, adjacent with, connected to, etc., a user interface element displaying an application output 105. Note that in this example the GenAI model 110 need not be integrated within application 104, but may nevertheless be used to provide application content (e.g., embedded GenAI explanation 106) directly within application 104. This beneficially allows for different GenAI models to be used (e.g., domain-specific) as well as for GenAI model 110 to be updated independently of application 104. Application 104 need only implement, in this example, a function for providing information to and receiving information from GenAI model 110. However, in other embodiments, GenAI model 110 may be a component of application 104.

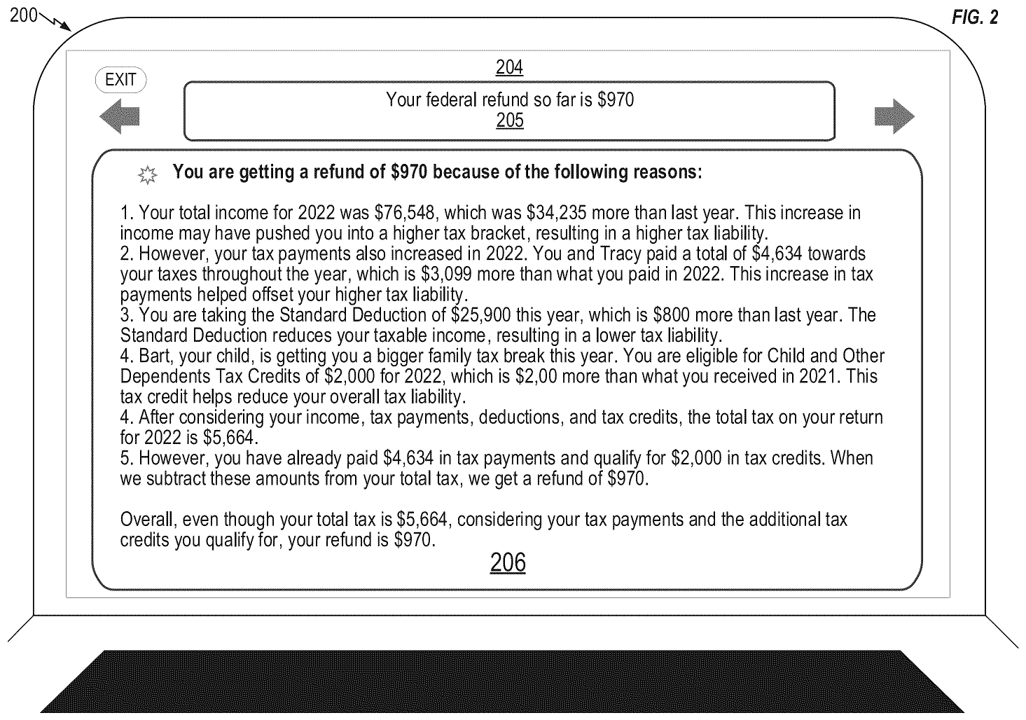

Application 104 may be a web-based application or a native application, in either case capable of running on a variety of computing devices, including personal computers, tablet computers, smart devices, and others. In the depicted example, application 104 includes a user interface configured to enable user 102 to interact with application 104 through a user computing device, for example, to input user information 108. FIG. 2 depicts an example user interface of application 104.

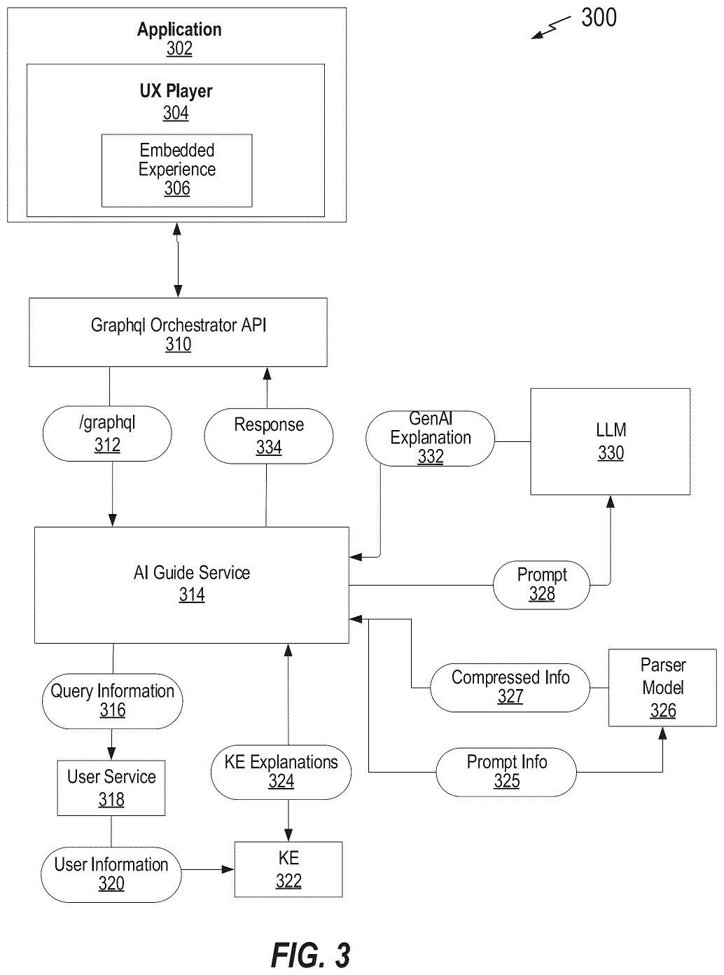

According to aspects described herein in further detail, such as with respect to FIGS. 3, 4, and 5 below, application 104 is configured to interact with GenAI model 110 to generate such embedded GenAI explanations 106. GenAI model 110 utilizes user application information 112 received from application 104. GenAI model 110 may beneficially generate an accurate and GenAI explanation based on prompting GenAI model 110 with user application information 112. User application information 112 may comprise, information associated with a user, such as user information 108 inputted to application 104. For an example tax return preparation application, user information may include user income information, tax payment information, and demographic information. User application information 112 may, additionally, and/or alternatively, comprise domain knowledge, determinations, and/or calculations made by application 104, such as to generate application output 105. For an example tax return preparation application, user tax deduction information, user tax credit information, user tax filing status, tax code regulations and guidance, etc. As described herein, a GenAI explanation is a meaningful explanation of the application output 105 in a manner intended for a non-expert. Thus, user 102 is not required to seek out an explanation using inferior tools and information, such as conventional “help” materials, like FAQs, which are often implemented outside of application 104's interface, as described above.

GenAI model 110 may be an LLM, for example, a generative pre-trained transformer (GPT) model, trained to process a prompt comprising user application information 112 and to generate GenAI explanation 114. GenAI model 110 returns the GenAI explanation 114 to application 104, which may then display the GenAI explanation as embedded GenAI explanation 106 within a user interface of application 104.

Thus, beneficially, the GenAI explanation may be displayed within the application user interface (e.g., as depicted in example user interface 200 in FIG. 2) and associated with the application output 105, improving usability by reducing navigation between sections of application 104, for example, to a help section.

### Example User Interface for Domain-Specific Application With Integrated Generative AI Output

FIG. 2 depicts example user interface 200 with a GenAI explanation 206 based on application output 205. In this example, a user interacts with an income tax return application 204 (e.g., an example of application 104 in FIG. 1), and receives an application output 205 of an estimated tax refund based on the user's income tax return. Additionally, the user also receives a GenAI explanation 206 based on application output 205. The GenAI explanation 206 is embedded within user interface 200, for example, as an inline widget. As described above, this presents the user with both the application output 205 and the reasoning for that output (e.g., GenAI explanation 206) in a unified interface, which is an improvement to the user interface compared to conventional systems.

In this example, GenAI explanation 206 describes a user-specific explanation of the user's estimated tax refund based on the user income tax return and other user-specific information, such as, in this example, the user's filing status, previous tax information, and the like. Thus, the user beneficially receives a personalized explanation of the application output 205, and domain-specific information (e.g., tax rules) related to in the application output 205. Further, the explanation is narrowly tailored to the application output 205, for example, by providing relevant domain information, e.g., tax liability and tax payment information, which was used by the application 204 to generate the application output 205. Moreover, the GenAI explanation 206 comprises a human understandable text output to provide a clear and concise explanation.

Note that while not explicitly shown here, application 204 may use a knowledge engine (either an integral part of application 204, or an external component (e.g., accessed through an API, such as in a microservices-type deployment)) to generate application output 205, and information used by the knowledge engine (not depicted) may be provided to the GenAI component as part of the input prompt that results in GenAI explanation 206.

### Example Workflow for Generating and Displaying Generative AI Explanations of Application Output

FIG. 3 depicts an example system 300 for generating and displaying GenAI explanations of an application output, for example, within application 104 in FIG. 1 and/or depicted in user interface 200 in FIG. 2, based on a GenAI model. In this example, the GenAI model is an LLM.

Application 302 may be an example of application 104 in FIG. 1. In this example, application 302 comprises a domain-specific application, including, for example, tax calculation and preparation applications, customer support applications, medical diagnosis applications, media and content applications, and others. Application 302 comprises a user experience player 304 configured to display a user interface of application 302. User experience player 304 is configured to display the application output (e.g., application output 105 in FIG. 1) on the user interface of application 302.

In embodiments, user experience player 304 is configured to display a GenAI explanation of the application output as an embedded experience 306. Based on determination of an output by application 302, and user experience player 304 is configured to request a GenAI explanation for display as embedded experience 306. User interface 200 in FIG. 2 is an example of a user interface displayed by user experience player 304. Embedded experience 306 may comprise a user interface element, such as an inline widget for display of the GenAI explanation.

A GenAI explanation 332, such as GenAI explanation 114 in FIG. 1, is obtained from a GenAI model (in this example, LLM 330) based on a prompt including user and application information.

In this example, application 302 obtains the GenAI explanation via graphql orchestrator API 310. Graphql orchestrator API 310 is an application programming interface (API) configured to interface application 302 with the AI guide service 314, such as to query AI guide service 314 for the GenAI explanation. In this example, graphql orchestrator API 310 transmits a graphql protocol query 312 to AI guide service 314. Graph query language (graphql) is a query language for APIs configurable to fetch, organize, and provide data from data sources. In certain embodiments, graphql orchestrator API 310 may utilize other query protocols, for example, a restSQL protocol associated with a RESTful API.

AI guide service 314 is configured to receive queries from API 310, for example, a query 312 to obtain a GenAI explanation based on application 302 determining an application output. Query 312 may include a request for a GenAI explanation of an application output, the application output, a user identifier, an application identifier. AI guide service 314 is further configured to obtain and provide the GenAI explanation in response to the query 312 from API 310. In embodiments, AI guide service 314 is configured to obtain the GenAI explanation 332 based on interfacing with various other services to generate a prompt for a GenAI explanation and obtain the GenAI explanation based on the prompt. In this example, AI guide service 314 is configured to interface with API 310, user service 318, knowledge engine 322, parser model 326, and LLM 330.

In this example, AI guide service 314 is configured to obtain user application session information 320 from user service 318 based on a query 316 for information. User service 318 provides user application session information, for example, one or more user attributes, one or more user activities within the application 302, one or more user inputs to the application 302, user location within the application 302, etc. In an example, user and application information for an income tax return application may include user demographic information, income information, household information, tax information, expenditure information, user application activity, and the like.

AI guide service 314 is further configured to obtain a knowledge engine explanation 324 from a knowledge engine 322. Knowledge engine 322 is configured to determine knowledge engine explanations 324 based on the user application session information 320. In some embodiments, knowledge engine 322 may comprise a domain-specific knowledge engine.

In an example, knowledge engine 322 may comprise a tax knowledge engine configured to make tax-related determinations based on user inputs within application 302. Knowledge engine 322 may comprise one or more data models and/or rules for a given domain, such as tax calculation for a particular country, state, etc. Based on the user application session information 320, knowledge engine 322 is configured to output one or more knowledge engine explanations 324.

For example, a tax knowledge engine may process user demographic information, income information, household information, tax information, expenditure information, and the like, according to one or more tax models and rules, to generate calculations and explanations, such as application of a tax credit, tax deduction, etc.

As another example, a medical diagnostic knowledge engine may process user medical information, user symptoms, user demographic information, and the like, in accordance with medical diagnostic models and rules, to generate medical diagnostic determinations and explanations. Such knowledge engine explanations 324 may not be readily comprehensible by a non-domain expert (e.g., a user 102). In embodiments, the knowledge engine explanations 324 may be outputted in a XML or JSON format, which facilitates downstream processing.

User application session information 320 and knowledge engine explanations 324 may be utilized by AI guide service 314 to augment a prompt 328 and thereby to guide the GenAI model (e.g., LLM 330) in generating a more meaningful and user-centric explanation (e.g., GenAI explanation 332). Beneficially, the GenAI model transforms complex, domain-specific application outputs (e.g., user application session information 320 and knowledge engine explanations 324) into a clear and concise explanation suitable for users.

AI guide service 314 is further configured to generate the prompt 328 based on the query 312 for an explanation associated with the application output, user application session information 320, and the knowledge engine explanations 324. The prompt 328 may be used to prompt a GenAI model, in this example LLM 330, to generate and output the GenAI explanation 332. In certain embodiments, a parser model 326 is configured to process prompt information 325, such as query 312, the user application session information 320 and the knowledge engine explanations 324, to generate compressed prompt information 327 comprising useful information extracted from query 312, user application session information 320 and knowledge engine explanations 324.

For example, in some examples, the knowledge engine explanations 324 may comprise a number of tokens greater than may be processed by the LLM 330. For example, the knowledge engine explanations 324 may comprise 20,000-50,000 tokens and the LLM 330 may have a limit of 10,000 tokens to process. In certain embodiments, AI guide service 314 may compress the prompt information 325 to generate a more compact prompt, e.g., having fewer tokens. For example, AI guide service 314 may concatenate the prompt information 325 to reduce the number of tokens of the prompt. In the depicted example, AI guide service 314 utilizes parser model 326 to parse the prompt information 325 to generate the prompt. Parser model 326 is trained to reduce the number of tokens of the prompt information 325 while maintaining the salient information so that LLM 330 can produce a meaningful explanation. By way of example, parser model 326 may be configured to extract relevant information elements from the prompt information 325 for use in the prompt 328 and sent to AI guide service 314 as compressed information 327.

AI guide service 314 is further configured to identify instructions based on the extracted information elements (e.g., compressed information 327) and add the instructions to the prompt 328. Such instructions may include instructions to guide the LLM 330 to perform the instructed task and generate the GenAI explanation. For example, an instruction may instruct the LLM to generate a human-readable explanation of the knowledge engine explanations 324, for example, text summarization, e.g., “Based on the information provided, answer the question, ‘Why is my refund not the same as last year?’”, or “Based on the information provided, answer the question, ‘Why is my refund $X?’” Another example instruction may instruct the LLM to generate the explanation targeting a non-expert audience. Other example instructions may instruct the LLM to output the explanation in a particular format, provide examples (e.g., few-shot demonstrations of input and output), and others. Instructions may be identified based on information extracted by parser model 326, based on the graphql protocol query 312, based on the application output, etc. For example, a text summarization instruction may be identified based on a query for an embedded GenAI explanation associated with an application output.

As described herein, a technical problem with GenAI models is reducing hallucinations. By providing explicit instructions with an input prompt to the LLM 330, the LLM 330 may generate a meaningful and accurate explanation based on the application output.

AI guide service 314 is configured to provide the prompt 328 to LLM 330 to obtain the GenAI explanation 332. AI guide service 314 receives a GenAI explanation 332 generated by LLM 330. In embodiments, LLM 330 may comprises a GPT model. LLM 330 is trained to process a prompt and generate a generative text output. In particular, LLM 330 may be trained to process a prompt for a GenAI explanation of an output in application 302.

The GenAI explanation 332 may comprise a human-understandable explanation of the application output, in particular, a domain- and user-specific explanation of an application output (e.g., 105 in FIGS. 1 and 205 in FIG. 2) based on the user's information, the application information, and the domain-specific knowledge and calculations generated by knowledge engine 322. For example, the GenAI explanation 332 may be an explanation of a user's tax refund amount, e.g., 206 in FIG. 2.

The GenAI explanation 332 is sent to AI guide service 314. AI guide service 314 responds to the graphql protocol query 312 from API 310 with response 334 comprising the GenAI explanation 332. The GenAI explanation is then displayed on the application user interface in embedded experience 306, for example, as an inline widget, such as depicted in FIG. 2. This integration improves usability and user experience.

System 300 provides many technical benefits by providing aspects for generation of relevant and accurate GenAI explanations and displaying such generative explanations within a user interface of an application to provide improved usability of the explanations. In certain embodiments, for example, a compact, yet meaningful prompt is generated. The prompt may include domain-specific information, which may further reduce incorrect and/or nonsensical generative output (e.g., reducing generative AI hallucination). Moreover, the prompt may be compressed, such as through the parser model, to a size manageable by the GenAI model. Compact prompts further reduce resource usage and reduce latency of the end-to-end process of providing the explanation to application 302.

### Example Sequence Flow for Generating a Generative AI Explanation

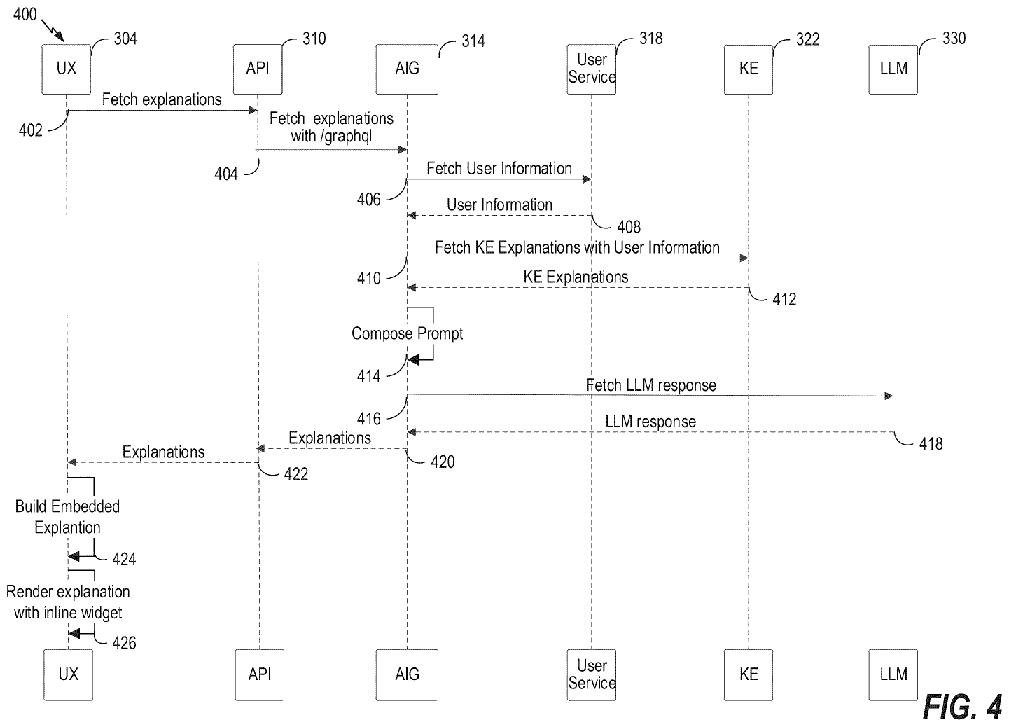

FIG. 4 depicts an example sequence diagram of method 400 for generating a GenAI explanation associated with an application output. Method 400 is described with respect to various components of system 300 of FIG. 3.

At step 402, user experience player 304 sends a request to API 310 to fetch a GenAI explanation for display as an embedded experience 306, for example, a user interface element for display on a user interface associated with application 302. FIG. 2 depicts an example user interface 200 displaying an embedded GenAI explanation 206. User experience player 304 may send the request based on a determination of an output by application 302.

At step 404, API 310 requests the GenAI explanation using a graphql protocol from AI guide service 314. As described herein, AI guide service 314 is configured to interface with user service 318, knowledge engine 322, and LLM 330 to generate a GenAI explanation and response to the request from API 310.

At step 406, AI guide service 314 requests user application session information from user service 318. At step 408, user service 318 returns user application session information (e.g., user application session information 320). User application session information may include user and application information, for example, one or more user attributes, one or more user activities within the application 302, one or more user inputs to the application 302, user location within the application 302, etc.

At step 410, AI guide service 314 requests knowledge engine explanations (e.g., knowledge engine explanation 324) associated with the user application session information 320 from the knowledge engine 322. In some embodiments, knowledge engine 322 is a domain-specific knowledge engine. Examples include a domain-specific knowledge engine for a tax domain comprising tax knowledge, rules, and models, a domain-specific knowledge engine for a medical diagnosis domain comprising medical diagnostic knowledge, rules, and models, and others. At step 412, knowledge engine 322 returns the knowledge engine explanations associated with the user application session information. In some embodiments, the knowledge engine explanations are provided in an XML format. A knowledge explanation may comprise labeled, categorized, and structured data including data explaining one or more determinations made by the knowledge engine in generating the application output. For example, a knowledge engine explanation for a tax domain may comprise one or more tax calculations (e.g., income, taxable income, tax paid, tax credit, etc.) and associated explanations (e.g., child tax credit applied based on qualifying child). Such knowledge engine explanations may not be reader friendly, for example, targeted to a domain-expert, such as including domain-expert terminology, knowledge, and readability.

At step 414, AI guide service 314 composes a prompt for an LLM based on the knowledge engine explanations 324 and user application session information 320. For a tax preparation application, an example prompt may comprise a request for an explanation of a user's income, taxable income, tax paid, tax credit, etc. and associated knowledge engine explanations. In some embodiments, composing the prompt comprises identifying one or more instructions and adding the one or more instructions to the knowledge explanations. For example, an instruction to generate a GenAI explanation may include an instruction to complete the task of text summarization of the knowledge engine explanations. As another example, an instruction may include one or more example inputs and outputs. For example, a prompt may comprise an instruction to complete the task of a text summary of provided knowledge engine data (e.g., knowledge engine explanation 324), targeted towards Tom, a non-expert end user (e.g., user 102). The prompt may further comprise one or more demonstrative examples of input data and a text summary output. By providing explicit instructions with an input prompt to the LLM 330, the LLM 330 may generate a meaningful and accurate explanation based on the application output.

In some embodiments, composing the prompt comprises compressing the knowledge engine explanations. In some embodiments, composing the prompt comprises parsing the knowledge engine explanations with a parsing model to reduce the number of tokens of the prompt. For example in a tax preparation application, the knowledge engine explanations may comprise:

```
<TaxReturn>
  <Input>
    < Key>Income</Key>
    <Value>76548</Value>
  </Input>
  <Input>
    <Key>TaxesPaid</Key>
    <Value>4634</Value>
  </Input>
</TaxReturn>.
```

A compressed prompt may comprise:
Income: 76548, TaxesPaid: 4634.

As described herein, a prompt with many tokens may be too large to be processed by the GenAI model, for example, too large for the memory of the model, and/or require extensive resources and time to process the prompt and generate an explanation. By compressing or parsing the prompt, resource usage and latency may be reduced and the GenAI model may process the prompt.

At step 416, AI guide service 314 requests an LLM response from LLM 330 based on the prompt. At step 418, LLM 330 returns an LLM response to AI guide service 314. In embodiments, LLM 330 processes the prompt to generate a text output, for example, a domain- and user-specific explanatory text of an application output, e.g., a GenAI explanation 332. For example, LLM 330 may generate GenAI explanation 206 in FIG. 2.

At step 420, AI guide service 314 sends the response 334 comprising the GenAI explanation 332 in response to the request from API 310.

At step 422, API 310 provides the GenAI explanation to the user experience player 304. At step 424, the user experience player 304 builds a user interface element comprising embedded experience 306. In embodiments, the user interface element comprises an inline widget. In some embodiments, the user interface element comprises an embedded widget.

At step 426, the user experience player 304 renders the GenAI explanation as part of the user interface element to display the GenAI explanation within the user interface of the application, for example, as depicted in FIG. 2. Beneficially, the explanation generated by the generative model may be displayed within and integrated with an application's user interface, e.g., user interface 200 in FIG. 2, improving usability for the user and avoiding the conventional requirement for a user to navigate to different portions of the application (e.g., a help section) for generic explanations associated with application output.

Method 400 provides many technical benefits through generation of relevant and accurate GenAI explanations and displaying such generative explanations within a user interface of an application, such as depicted in FIG. 2, to provide improved usability of the explanations. For example, in certain embodiments, a compact and meaningful prompt may be generated. The prompt may include domain-specific information, which may further reduce incorrect and/or nonsensical generative output (e.g., reducing generative AI hallucination). Moreover, the prompt may be compressed, such as through the parser model, to a size manageable by the GenAI model. Compact prompts further reduce resource usage and reduce latency of the end-to-end process of providing the explanation to application 302. Thereby, meaningful explanations may be readily generated in association with application outputs as a user utilizes application 302.

Note that FIG. 4 is just one example of a method, and other methods including fewer, additional, or alternative steps are possible consistent with this disclosure.

### Example Method for Generating Generative AI Explanations

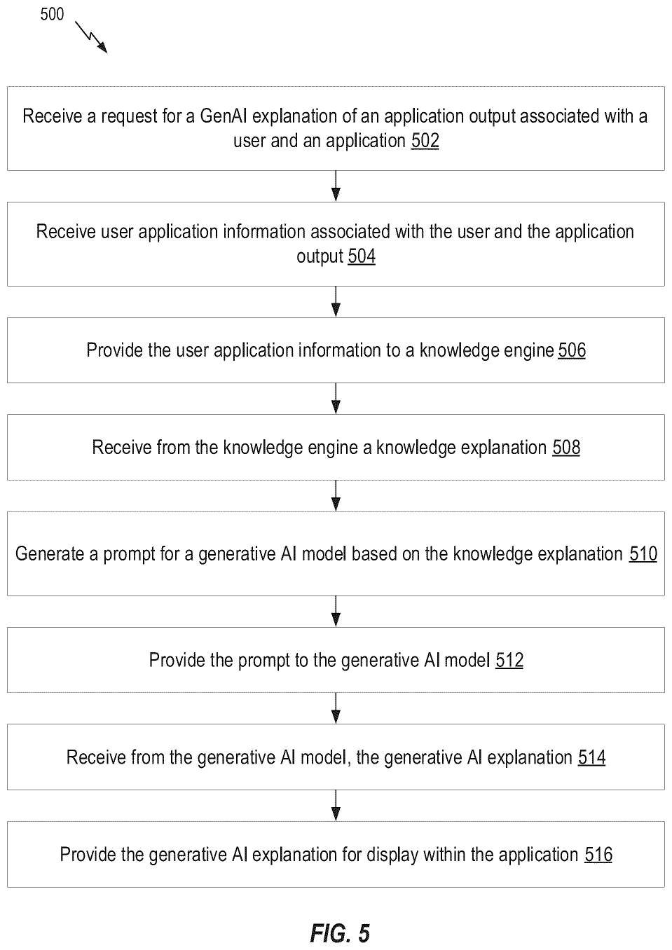

FIG. 5 depicts an example method 500 for generating a GenAI explanation of an application output associated with a user and an application. Example applications include application 104 in FIG. 1, application 204 in FIG. 2, or application 302 in FIG. 3.

Initially, method 500 begins at step 502 with receiving a request for a generative artificial intelligence (AI) explanation of an application output associated with a user and an application, e.g., user 102 and application 104 in FIG. 1. In some embodiments, the request is received via a graphql protocol from a user interface (UI) component of the application, e.g., from user experience player 304 in FIGS. 3 and 4. A GenAI explanation of the application output may comprise a user and domain-specific explanation of the application activity and reasoning to generate the output in a technically accurate and concise manner.

Method 500 proceeds to step 504 with receiving user information associated with the user and the application output, for example, user service 318 as described with respect to FIGS. 3 and 4.

Method 500 then proceeds to step 506 with providing the user information to a knowledge engine, for example, knowledge engine 322 in FIGS. 3 and 4.

Method 500 proceeds to step 508 with receiving from the knowledge engine a knowledge explanation, for example, knowledge engine explanations 324 in FIGS. 3 and 4.

Method 500 then proceeds to step 510 with generating a prompt for a GenAI model based on the knowledge explanation, for example as described with respect to step 414 in FIG. 4.

In some embodiments, the knowledge explanation is in XML format, and method 500 further comprises parsing the knowledge explanation for information elements used in the prompt for the GenAI model.

In some embodiments, method 500 further comprises identifying one or more instructions based on the information elements; and adding the one or more instructions to the prompt for the GenAI model. In some embodiments, the information elements are parsed by processing the knowledge explanation with a parser model trained to reduce a number of tokens of the prompt for the GenAI model, for example, processing with parser model 326 in FIG. 3.

In some embodiments, generating the prompt for the GenAI model based on the knowledge explanation, comprises compressing the prompt. As described, the knowledge explanations may exceed a prompt threshold size for the GenAI model, and prompt size reduction techniques, e.g., compression and/or token number reduction, allow providing a meaningful prompt that is usable by the GenAI model to generate the GenAI explanation.

Method 500 proceeds to step 512 with providing the prompt to the GenAI model. In some embodiments, the GenAI model is a large language machine learning model, for example, LLM 330 in FIGS. 3 and 4. In some embodiments, the GenAI model is a generative pre-trained transformer model.

Method 500 then proceeds to step 514 with receiving from the GenAI model the GenAI explanation, such as described at step 422 in FIG. 4. In some embodiments, the GenAI explanation comprises a user-specific explanation of the application output.

Method 500 proceeds to step 516 with providing the GenAI explanation for display within the application, for example, as depicted in FIG. 2. Display of the GenAI explanation within the application beneficially improves usability of the application output and the GenAI explanation by avoiding the conventional method of a user navigating between different sections to obtain a generic explanation.

Note that FIG. 5 is just one example of a method, and other methods including fewer, additional, or alternative steps are possible consistent with this disclosure.

### Example Processing System for Generating Generative AI Explanations

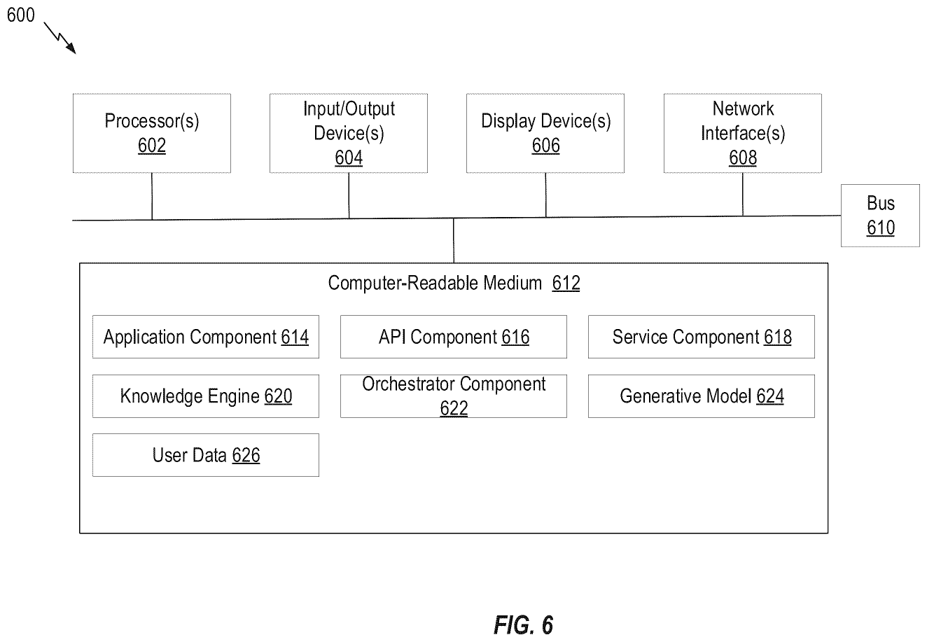

FIG. 6 depicts an example processing system 600 configured to perform various aspects described herein, including, for example, method 400 in FIG. 4, and/or method 500 in FIG. 5, as described above.

Processing system 600 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 600 includes one or more processors 602, one or more input/output devices 604, one or more display devices 606, one or more network interfaces 608 through which processing system 600 is connected to one or more networks (e.g., a local network, an intranet, the Internet, or any other group of processing systems communicatively connected to each other), and computer-readable medium 612. In the depicted example, the aforementioned components are coupled by a bus 610, which may generally be configured for data exchange amongst the components. Bus 610 may be representative of multiple buses, while only one is depicted for simplicity.

Processor(s) 602 are generally configured to retrieve and execute instructions stored in one or more memories, including local memories like computer-readable medium 612, as well as remote memories and data stores. Similarly, processor(s) 602 are configured to store application data residing in local memories like the computer-readable medium 612, as well as remote memories and data stores. More generally, bus 610 is configured to transmit programming instructions and application data among the processor(s) 602, display device(s) 606, network interface(s) 608, and/or computer-readable medium 612. In certain embodiments, processor(s) 602 are representative of a one or more central processing units (CPUs), graphics processing unit (GPUs), tensor processing unit (TPUs), accelerators, and other processing devices.

Input/output device(s) 604 may include any device, mechanism, system, interactive display, and/or various other hardware and software components for communicating information between processing system 600 and a user of processing system 600. For example, input/output device(s) 604 may include input hardware, such as a keyboard, touch screen, button, microphone, speaker, and/or other device for receiving inputs from the user and sending outputs to the user.

Display device(s) 606 may generally include any sort of device configured to display data, information, graphics, user interface elements, and the like to a user. For example, display device(s) 606 may include internal and external displays such as an internal display of a tablet computer or an external display for a server computer or a projector. Display device(s) 606 may further include displays for devices, such as augmented, virtual, and/or extended reality devices. In various embodiments, display device(s) 606 may be configured to display a graphical user interface.

Network interface(s) 608 provide processing system 600 with access to external networks and thereby to external processing systems. Network interface(s) 608 can generally be any hardware and/or software capable of transmitting and/or receiving data via a wired or wireless network connection. Accordingly, network interface(s) 608 can include a communication transceiver for sending and/or receiving any wired and/or wireless communication.

Computer-readable medium 612 may be a volatile memory, such as a random access memory (RAM), or a nonvolatile memory, such as nonvolatile random access memory (NVRAM), or the like. In this example, computer-readable medium 612 includes application component 614, API component 616, service component 618, knowledge engine 620, orchestrator component 622, and generative model 624.

In certain embodiments, application component 614 is configured to interface with a user, for example, through a user interface, to facilitate one or more services and provide associated explanations. Application component 614 may be an example of application 104 in FIG. 1.

In certain embodiments, API component 616 is configured to provide one or more APIs to facilitate communication between one or more components, for example, facilitate sending and/or receiving requests and data. Examples of API component 616 may include API 310 in FIGS. 3 and 4.

In certain embodiments, service component 618 is configured to generate a GenAI explanation associated with application component 614, including, for example, generating a prompt for a GenAI explanation with GenAI model 624 and obtaining user data 626.

In certain embodiments, knowledge engine 620 is configured to provide explanations associated with application component 614, for example, as described with respect to knowledge engine 322 in FIGS. 3 and 4.

In certain embodiments, orchestrator component 622 is configured to select a generative model 624 for generating an explanation and obtain the explanation based on providing model 624 with the prompt.

Note that FIG. 6 is just one example of a processing system consistent with aspects described herein, and other processing systems having additional, alternative, or fewer components are possible consistent with this disclosure.

### Example Clauses

Implementation examples are described in the following numbered clauses:

Clause 1: A computer-implemented method, comprising: receiving a request for a generative artificial intelligence (AI) explanation of an application output associated with a user and an application; receiving user application session information associated with the user and the application output; providing the user application session information to a knowledge engine; receiving from the knowledge engine an explanation; generating a prompt for a generative AI model based on the explanation; providing the prompt to the generative AI model; receiving from the generative AI model the generative AI explanation; and providing the generative AI explanation for display within the application.

Clause 2: The computer-implemented method of Clause 1, wherein: the explanation is in XML format, and the computer-implemented method further comprises parsing the explanation for information elements used in the prompt for the generative AI model.

Clause 3: The computer-implemented method of Clause 2, further comprising: identifying one or more instructions based on the information elements; and adding the one or more instructions to the prompt for the generative AI model.

Clause 4: The computer-implemented method of any one of Clauses 2-3, wherein the information elements are parsed by processing the explanation with a parser model trained to reduce a number of tokens of the prompt for the generative AI model.

Clause 5: The computer-implemented method of any one of Clauses 1-4, wherein generating the prompt for the generative AI model based on the explanation, comprises compressing the prompt.

Clause 6: The computer-implemented method of any one of Clauses 1-5, wherein the request is received via a graphql protocol from a user interface (UI) component of the application.

Clause 8: The computer-implemented method of any one of Clauses 1-7, wherein the generative AI explanation comprises a user-specific explanation of the application output.

Clause 9: The computer-implemented method of any one of Clauses 1-8, wherein the generative AI model is a large language machine learning model.

Clause 10: A processing system, comprising: a memory comprising computer-executable instructions; and a processor configured to execute the computer-executable instructions and cause the processing system to perform a method in accordance with any one of Clauses 1-9.

Clause 11: A processing system, comprising means for performing a method in accordance with any one of Clauses 1-9.

Clause 12: A non-transitory computer-readable medium storing program code for causing a processing system to perform the steps of any one of Clauses 1-9.

Clause 13: A computer program product embodied on a computer-readable storage medium comprising code for performing a method in accordance with any one of Clauses 1-9.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method, comprising:
receiving a request for a generative artificial intelligence (AI) explanation of an application output associated with a user and an application;
receiving user application session information associated with the user and the application output;
providing the user application session information to a knowledge engine;
receiving from the knowledge engine a knowledge explanation;
generating a prompt for a generative AI model based on the knowledge explanation;
providing the prompt to the generative AI model;
receiving from the generative AI model the generative AI explanation; and
providing the generative AI explanation for display within the application.

2. The computer-implemented method of claim 1, wherein:
the knowledge explanation is in XML format, and
the computer-implemented method further comprises parsing the knowledge explanation for information elements used in the prompt for the generative AI model.

3. The computer-implemented method of claim 2, further comprising:
identifying one or more instructions based on the information elements; and
adding the one or more instructions to the prompt for the generative AI model.

4. The computer-implemented method of claim 1, wherein the request is received via a graphql protocol from a user interface (UI) component of the application.

5. The computer-implemented method of claim 2, wherein the information elements are parsed by processing the explanation with a parser model trained to reduce a number of tokens of the prompt for the generative AI model.

6. The computer-implemented method of claim 1, wherein generating the prompt for the generative AI model based on the explanation, comprises compressing the prompt.

7. The computer-implemented method of claim 1, wherein the generative AI explanation comprises a user-specific explanation of the application output.

8. The computer-implemented method of claim 1, wherein the generative AI model is a large language machine learning model.

9. A processing system, comprising: a memory comprising computer-executable instructions; and a processor configured to execute the computer-executable instructions and cause the processing system to:
receive a request for a generative artificial intelligence (AI) explanation of an application output associated with a user and an application;
receive user application session information associated with the user and the application output;
provide the user application session information to a knowledge engine;
receive from the knowledge engine a knowledge explanation;
generate a prompt for a generative AI model based on the knowledge explanation;
provide the prompt to the generative AI model;
receive from the generative AI model the generative AI explanation; and
provide the generative AI explanation for display within the application.

10. The processing system of claim 9, wherein:
the knowledge explanation is in XML format, and
the processor is further configured to cause the processing system to parse the knowledge explanation for information elements used in the prompt for the generative AI model.

11. The processing system of claim 10, the processor is further configured to cause the processing system to:
identify one or more instructions based on the information elements; and
add the one or more instructions to the prompt for the generative AI model.

12. The processing system of claim 9, wherein the request is received via a graphql protocol from a user interface (UI) component of the application.

13. The processing system of claim 10, wherein the information elements are parsed by processing the knowledge explanation with a parser model trained to reduce a number of tokens of the prompt for the generative AI model.

14. The processing system of claim 9, wherein the generative AI explanation comprises a user-specific explanation of the application output.

15. The processing system of claim 9, wherein the generative AI model is a large language machine learning model.

16. A computer-implemented method, comprising:
receiving a request for a generative artificial intelligence (AI) explanation of an application output associated with a user and an application;
receiving user application session information associated with the user and the application output;
providing the user application session information to a knowledge engine;
receiving from the knowledge engine a knowledge explanation;
generating a prompt for a generative AI model based on the knowledge explanation, comprising:
parsing the knowledge explanation with a parser model to identify information elements, wherein the parser model is trained to reduce a number of tokens of the prompt;
identifying one or more instructions based on the information elements; and
adding the information elements and the one or more instructions to the prompt for the generative AI model;
providing the prompt to the generative AI model;
receiving from the generative AI model the generative AI explanation; and
providing the generative AI explanation for display within the application.

17. The computer-implemented method of claim 16, wherein the knowledge explanation is in XML format.

18. The computer-implemented method of claim 16, wherein the request is received via a graphql protocol from a user interface (UI) component of the application.

19. The computer-implemented method of claim 16, wherein the generative AI model is a large language machine learning model.

20. The computer-implemented method of claim 16, wherein the generative AI explanation comprises a user-specific explanation of the application output.
